(19) United States
(12) Patent Application Publication
(10) Pub. No.: US 2012/0013428 A1
(43) Pub. Date: Jan. 19, 2012

(54) STEP-DOWN AUTOTRANSFORMER FOR A POWER DISTRIBUTION SYSTEM WITH NON-LINEAR LOADS

(76) Inventor: Tony Hoevenaars, Brampton (CA)

(21) Appl. No.: 12/838,161

(22) Filed: Jul. 16, 2010

(51) Int. Cl. H01F 27/29

(52) U.S. Cl. 336/192

(57) ABSTRACT

A step-down autotransformer for a power distribution system with 1-phase non-linear loads according to the invention provides at least one output for each phase. In two-output embodiments the outputs in each output pair have a different voltage than the input voltage and are phase-shifted by 30 degrees to cancel or substantially reduce the 5^{th} and 7^{th} harmonic currents. The autotransformer of the invention also cancels or substantially reduces zero phase sequence (ZPS) harmonic currents by providing a number of turns of windings between the neutral and each output oriented in a positive direction to be substantially equal to the number of turns of windings between the neutral and each output oriented in a negative direction. A single-output embodiment provides one output for each phase and therefore does not introduce a 30 degree phase shift for cancellation of 5^{th} and 7^{th} harmonic currents, but cancels or substantially reduces zero phase sequence (ZPS) harmonic currents by providing a lower impedance path. The zig-zag connections provide a neutral return path for 1-phase ground faults.

### FIELD OF THE INVENTION

This invention relates to power distribution systems with 1-phase non-linear loads. In particular, this invention relates to a step-down autotransformer for a power distribution system with 1-phase non-linear loads.

### BACKGROUND OF THE INVENTION

With the ever increasing power densities of today's computer equipment, energy consumption in data centers has grown rapidly in recent years. Power consumption by data centers more than doubled between the years 2000 and 2006, and some estimates predict that data center electrical requirements will double again by the year 2011.

A typical data center in the United States has a 277/480V, 3 phase, 3- or 4-wire incoming electrical service, and incorporates a 480V three phase 3-wire uninterruptible power supply (UPS). FIG. 1 illustrates such a typical data center power distribution system 10. It will be appreciated that the power distribution system illustrated in FIG. 1 has been simplified for purposes of illustration, or as a more complex system may involve back-up power generation, redundant UPS systems, dual redundant power supplies, static or mechanical transfer switches, busway distribution, etc.; however, broadly speaking typically the output of the UPS 12 is fed to a plurality of 3-phase, 3-wire 480V input power distribution units (PDU's) 14, which transform the voltage via a delta-wye transformer. The wye secondary of the transformer in the PDU 14 provides a neutral return path for 1-phase loads and creates a ground-fault return path for 1-phase faults downstream of the PDU 14. Electrical supply to the server racks in such a system is typically 120/208V, 3 phase, 4-wire. Thus, PDU's 14 having delta-wye isolation transformers are used to transform the voltage from 480V to 120/208V.

Typical power supplies used in computing equipment are designed to be used universally around the world. As such, computing equipment power supplies are operable over a wide range of voltages, for example 100V to 240V, so that they operate on European and North American voltage standards, as well as others. Power losses from computer equipment power supplies are reduced when they are operating at higher voltages. Thus, in the European 415V system where the phase-to-neutral voltage is 240V, the computer equipment power supply operates at a higher efficiency than the same computer equipment power supply operating under the North American standard 208V system where the phase-to-neutral voltage is 120V.

Accordingly, the same computer equipment power supplies which operate at 240V in Europe could also operate advantageously in data centers in North America if operated at 240V. Of particular benefit is the savings in energy consumption due to the more efficient operation of the computer equipment and the elimination of step-down isolation transformers.

FIG. 2 illustrates a typical North American data center power supply configuration 20 that incorporates a standard European design 400V UPS unit 22. This UPS 22 must be fed by a delta-wye isolation transformer 26 in order to step-down voltage from 480V to 230/400V 3-phase, 4-wire. The UPS 22 then provides a 230/400V, 3 phase, 4-wire output (with neutral) to at least one 230/400V power panel 24, which provides the power supply for the computing equipment. Although this is one method by which European voltages could be applied in a North American data center, it is not the most optimum. The 400V UPS which is standard in Europe is not standard in North America and would need to be certified for use in North America, which would normally limit available suppliers of the UPS 22. Further, an input isolation transformer 26 is required to transform the voltage from the 480V mains voltage to 400V; an autotransformer would not provide suitable isolation between the upstream neutral in the 480V system and the downstream neutral in the 400V system. Without this isolation, two ground return paths would be created during a phase-to-ground fault, which is contrary to code requirements. Further, a neutral conductor would have to be connected from the 400V side of the isolation transformer 26 to the server racks, and such a neutral would typically have to be overrated (even with power factor corrected power supplies) because of the third and other triplen harmonic currents which can overload a neutral.

### BRIEF DESCRIPTION OF THE DRAWINGS

In drawings which illustrate by way of example only a preferred embodiment of the invention,

FIG. 1 is a schematic diagram of a typical power distribution system configuration in a North American data center.

FIG. 2 is a schematic diagram of a typical power distribution system in a North American data center using a European designed UPS for power distribution at 230/400V.

FIG. 3 is a schematic diagram of a power distribution system according to the invention.

FIG. 4 is a vector diagram of a first embodiment of autotransformer for the remote panel boards in the system of FIG. 3.

FIG. 4A is a winding diagram of the autotransformer of FIG. 4.

FIG. 5 is a vector diagram of a further embodiment of a step-down autotransformer for the remote panel boards in the system of FIG. 3.

FIG. 6 is a vector diagram of a still further embodiment of a step-down autotransformer for the remote panel boards in the system of FIG. 3.

FIG. 7 is a vector diagram of a single-output embodiment of a step-down autotransformer for the remote panel boards in the system of FIG. 3.

### DETAILED DESCRIPTION OF THE INVENTION

The invention is particularly suitable for the power distribution system in a data center. However, a step-down autotransformer according to the invention may be used in many other applications and the invention is not so limited.

A step-down autotransformer according to the invention provides an output pair for each phase, the outputs in each pair having a lower voltage than the input voltage and being phase-shifted by 30 degrees to cancel or substantially reduce the 5^{th} and 7^{th} harmonic currents. The autotransformer of the invention also cancels or substantially reduces zero phase sequence (ZPS) harmonic currents by providing the number of turns of windings between the neutral and each output oriented in a positive direction to be substantially equal to the number of turns of windings between the neutral and each output oriented in a negative direction. This orientation also provides a neutral return path for 1-phase fault currents. An example of a transformer with a low ZPS impedance which cancels or substantially reduces ZPS harmonics is described in U.S. Pat. No. 5,801,610 issued Sep. 1, 1998 to Levin, which is incorporated herein by reference.

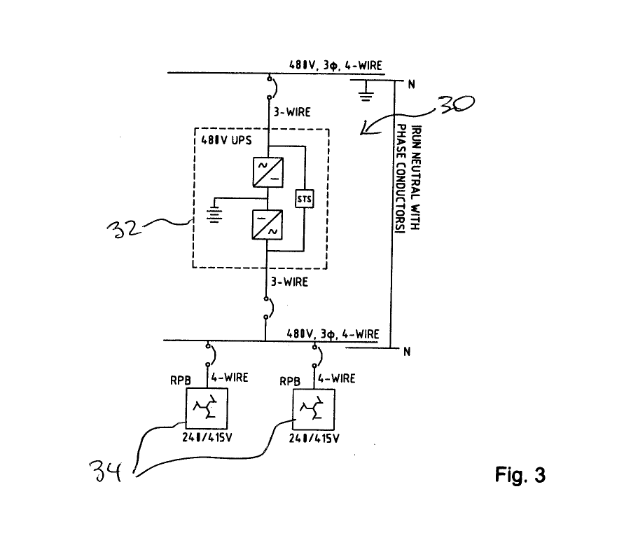

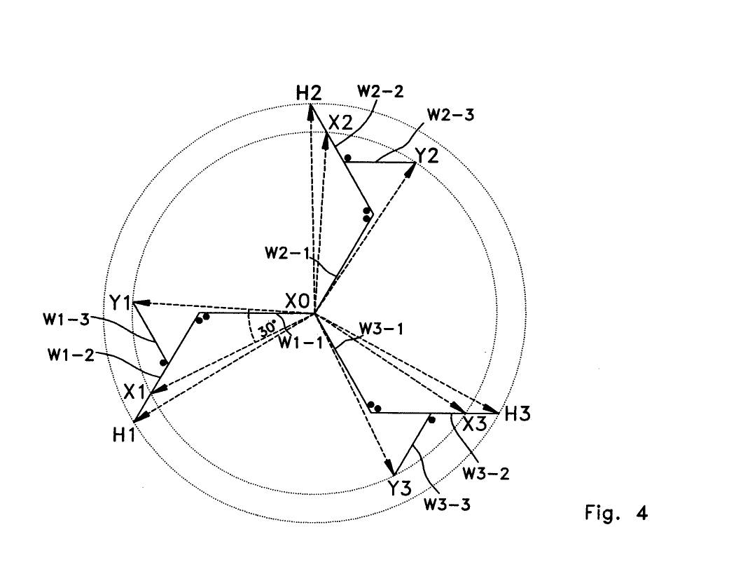

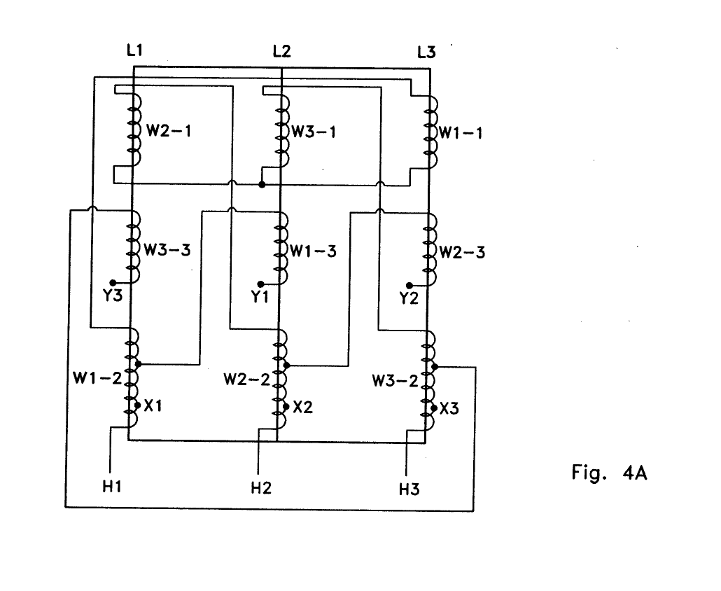

FIG. 3 illustrates a 480V, 3 phase, 4-wire distribution system 30 according to the invention. The 480V mains power supply is connected, matching phase to phase, to a 480V UPS 32 which in turn is connected, matching phase to phase, to at least one remote panel board (RPB) 34, preferably to a plurality of RPB's 34. The RPB comprises a step-down autotransformer according to the invention, various embodiments of which are illustrated in FIGS. 4 to 7.

Four different configurations of a step-down autotransformer according to the invention are illustrated in FIGS. 4 to 7. In each case the autotransformer is a three phase zig-zag transformer in which each phase of the secondary comprises windings located on different core legs of the transformer core. An example of a zig zag transformer secondary configuration is described in U.S. Pat. No. 5,801,610 for a Phase Shifting Transformer with Low Zero Phase Sequence Impedance issued Sep. 1, 1998 to Levin, which is incorporated herein by reference.

In the embodiments of FIGS. 4 to 6, the primary comprises inputs H1, H2, H3 respectively associated with each of the three phases, and the secondary comprises paired outputs X1, Y1; X2, Y2; and X3, Y3 respectively associated with the inputs H1, H2 and H3. The corresponding phases will be referred to herein respectively as Phase 1, Phase 2 and Phase 3, moving in a clockwise direction about the vector diagram; it being appreciated that any of the three phases can be designated as Phase 1.

In the embodiment illustrated in FIG. 4, the Phase 1 input H1 is connected to a winding W1-2 having a negative orientation on the Phase 1 core leg L1, which in turn is connected to a winding W1-1 having a positive orientation on the Phase 3 core leg L3. Similarly, the Phase 2 input H2 is connected to a winding W2-2 having a negative orientation on the Phase 2 core leg L2, which in turn is connected to a winding W2-1 having a positive orientation on the Phase 1 core leg L1; and the Phase 3 input H3 is connected to a winding W3-2 having a negative orientation on the Phase 3 core leg L3, which in turn is connected to a winding W3-1 having a positive orientation on the Phase 2 core leg L2. FIG. 4A is a winding diagram showing the connections represented by the vector diagram of FIG. 4, as is known to those skilled in the art.

For the secondary in the autotransformer of FIG. 4, the first Phase 1 output X1 is tapped from the winding W1-2, and the second Phase 1 output Y1 is connected to the end of a winding W1-3 having a negative orientation on the Phase 2 core leg. The phase shift between outputs X1 and Y1 is determined by the length of the winding W1-3, which is selected along with the length of winding W1-1 and the tap point in winding W1-2 for the connection to winding W1-3 so that the outputs X1 and Y1 have the desired voltage and phase shift between them. The first Phase 2 output X2 is tapped from the winding W2-2, and the second Phase 2 output Y2 is connected to the end of a winding W2-3 having a negative orientation on the Phase 3 core leg. The phase shift between outputs X2 and Y2 is determined by the length of the winding W2-3, which is selected along with the length of winding W2-1 and the tap point in winding W2-2 for the connection to winding W2-3 so that the outputs X2 and Y2 have the desired voltage and phase shift between them. The first Phase 3 output X3 is tapped from the winding W3-2, and the second Phase 3 output Y3 is connected to the end of a winding W3-3 having a negative orientation on the Phase 1 core leg. The phase shift between outputs X3 and Y3 is determined by the length of the winding W3-3, which is selected along with the length of winding W3-1 and the tap point in winding W3-2 for the connection to winding W3-3 so that the outputs X3 and Y3 have the desired voltage and phase shift between them.

The input for each phase is connected to the full length of the second winding whereas the outputs for each phase are tapped into the second winding, thereby providing a stepped-down voltage to the outputs. This reduces the 480V UPS output to 415V, creating a phase-to-phase voltage of 240V for the operation of computing equipment power supplies at a higher efficiency. The third winding W1-3, W2-3 or W3-3 in each phase allows an additional degree of freedom to select both voltage levels and phase shifts between the output pairs for the output voltage and phase shift desired (in the embodiment shown, 415V phase shifted 30°). The phase shift of 30° between the dual outputs of each phase advantageously cancels the 5^{th} and 7^{th} harmonic currents. In addition, third harmonic and other triplen harmonic currents are provided an alternate low zero sequence impedance path to follow. This offloads these currents from the upstream neutral return path while also providing a neutral return path for 1-phase fault currents.

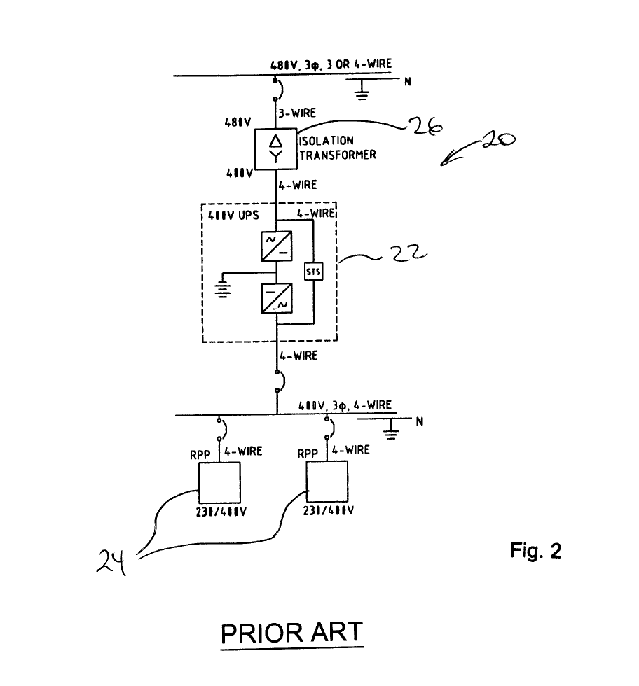

The two-output step-down autotransformer of the invention accordingly provides high power quality due to the cancellation of the 5^{th} and 7^{th} harmonic due to the 30 degree phase shift between outputs in each output pair; and the cancellation or substantial reduction of the third harmonic and other triplen harmonics from the upstream neutral return path because each output is connected to the neutral through windings on different core legs, such that the number of turns of windings between the neutral and each output oriented in a positive direction is substantially equal to the number of turns of windings between the neutral and each output oriented in a negative direction, thereby providing low ZPS impedance. At the same time, the step-down autotransformer of the invention provides output pairs each having 240/415V capability, without the need for a European designed UPS and isolation transformer as shown in the prior art system of FIG. 2, and the zig-zag connections provide a neutral return path for phase-to-neutral loads and 1-phase ground faults.

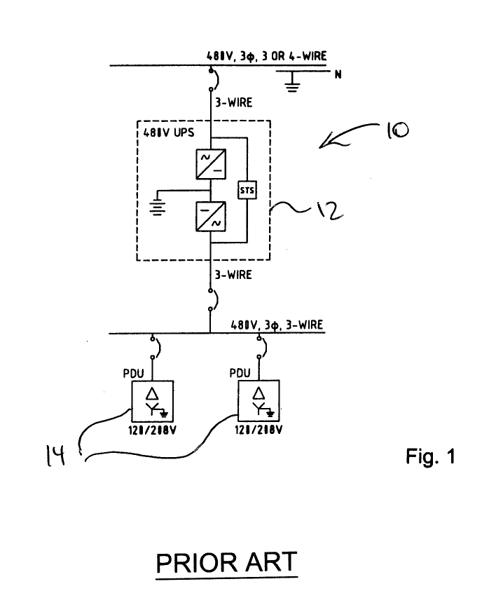

The power distribution system according to the invention also eliminates the need for isolation transformers in the PDU's used in the conventional North American system illustrated in FIG. 1, while resulting in more efficient power usage, and lowered voltage and current distortion for higher power quality with a commensurate reduction of harmonic losses in the UPS and associated cabling. This results in savings of energy and an associated reduction in energy costs, as well as a reduction in the cost of the infrastructure required for the power distribution system, while still taking advantage of existing infrastructure in standard North American power supply installations.

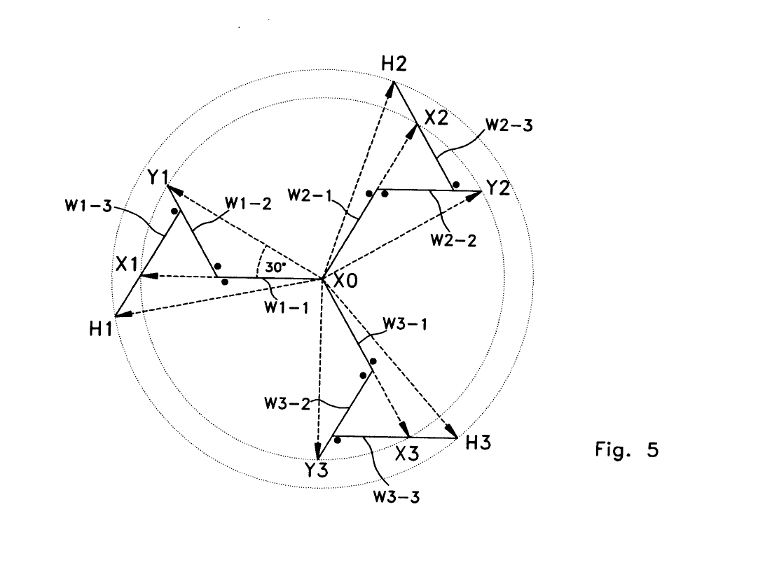

FIG. 5 illustrates a different configuration of the step-down autotransformer according to the invention. In this embodiment the Phase 1 input H1 is connected to a winding W1-3 having a negative orientation on the Phase 1 core leg, which is connected to a winding W1-2 having a negative orientation on the Phase 2 core leg, which in turn is connected to a winding W1-1 having a positive orientation on the Phase 3 core leg. The Phase 2 input H2 is connected to a winding W2-3 having a negative orientation on the Phase 2 core leg, which is connected to a winding W2-2 having a negative orientation on the Phase 3 core leg, which in turn is connected to a winding W2-1 having a positive orientation on the Phase 1 core leg. The Phase 3 input H3 is connected to a winding W3-3 having a negative orientation on the Phase 3 core leg, which is connected to a winding W3-2 having a negative orientation on the Phase 1 core leg, which in turn is connected to a winding W3-1 having a positive orientation on the Phase 2 core leg.

For the secondary in the autotransformer of FIG. 5, the first Phase 1 output X1 is tapped from the winding W1-3, which in turn is tapped from winding W1-2 at the appropriate position for the output voltage and phase shift desired (in the embodiment shown, 415V phase shifted 30°). The second Phase 1 output Y1 is connected to the end of winding W1-2. As in the previous embodiment, the phase shift between outputs X1 and Y1 is determined by the length of the winding W1-3, which is selected along with the length of winding W1-1 and the tap point in winding W1-2 for the connection to winding W1-3 so that the outputs X1 and Y1 have the desired voltage and phase shift. The first Phase 2 output X2 is tapped from the winding W2-3, which in turn is tapped from winding W2-2 at the appropriate position for the output voltage and phase shift desired. The second Phase 2 output Y2 is connected to the end of a winding W2-2. The phase shift separation between outputs X2 and Y2 is determined by the length of the winding W2-3, which is selected along with the length of winding W2-1 and the tap point in winding W2-2 for the connection to winding W2-3 so that the outputs X2 and Y2 have the desired voltage and phase shift. The first Phase 3 output X3 is tapped from the winding W3-3, which in turn is tapped from winding W3-2 at the appropriate position for the output voltage and phase shift desired. The second Phase 3 output Y3 is connected to the end of a winding W3-2. The phase shift separation between outputs X3 and Y3 is determined by the length of the winding W3-3, which is selected along with the length of winding W3-1 and the tap point in winding W3-2 for the connection to winding W3-3 so that the outputs X3 and Y3 have the desired voltage and phase shift.

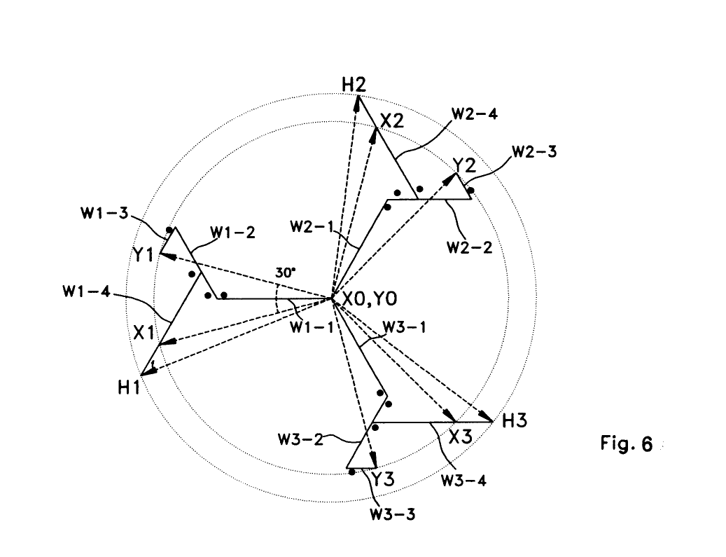

FIG. 6 illustrates a still further configuration of a step-down autotransformer according to the invention. In this embodiment, the Phase 1 input H1 is connected to a winding W1-4 having a negative orientation on the Phase 1 core leg, which is tapped from a winding W1-2 having a negative orientation on the Phase 2 core leg, which in turn is connected to a winding W1-1 having a positive orientation on the Phase 3 core leg. The Phase 2 input H2 is connected to a winding W2-4 having a negative orientation on the Phase 2 core leg, which is tapped from a winding W2-2 having a negative orientation on the Phase 3 core leg, which in turn is connected to a winding W2-1 having a positive orientation on the Phase 1 core leg. The Phase 3 input H3 is connected to a winding W3-4 having a negative orientation on the Phase 3 core leg, which is tapped from a winding W3-2 having a negative orientation on the Phase 1 core leg, which in turn is connected to a winding W3-1 having a positive orientation on the Phase 2 core leg.

For the secondary in the autotransformer of FIG. 6, the first Phase 1 output X1 is tapped from the winding W1-4, and the second Phase 1 output Y1 is connected to the end of a winding W1-3 having a negative orientation on the Phase 1 core leg and connected at its other end to the winding W1-2. The phase shift between outputs X1 and Y1 is determined by the length of the winding W1-3 and the tap point for winding W1-4, which are selected along with the lengths of windings W1-1 and W1-2 so that the outputs X1 and Y1 have the desired voltage and phase shift (in the embodiment shown, 415V phase shifted 30°). The first Phase 2 output X2 is tapped from the winding W2-4, and the second Phase 2 output Y2 is connected to the end of a winding W2-3 having a negative orientation on the Phase 2 core leg and connected at its other end to the winding W2-2. The phase shift between outputs X2 and Y2 is determined by the length of the winding W2-3 and the tap point for winding W2-4, which are selected along with the lengths of windings W2-1 and W2-2 so that the outputs X2 and Y2 have the desired voltage and phase shift. The first Phase 3 output X3 is tapped from the winding W3-4, and the second Phase 3 output Y3 is connected to the end of a winding W3-3 having a negative orientation on the Phase 3 core leg and connected at its other end to the winding W3-2. The phase shift between outputs X3 and Y3 is determined by the length of the winding W3-3 and the tap point for winding W3-4, which are selected along with the lengths of windings W3-1 and W3-2 so that the outputs X3 and Y3 have the desired voltage and phase shift.

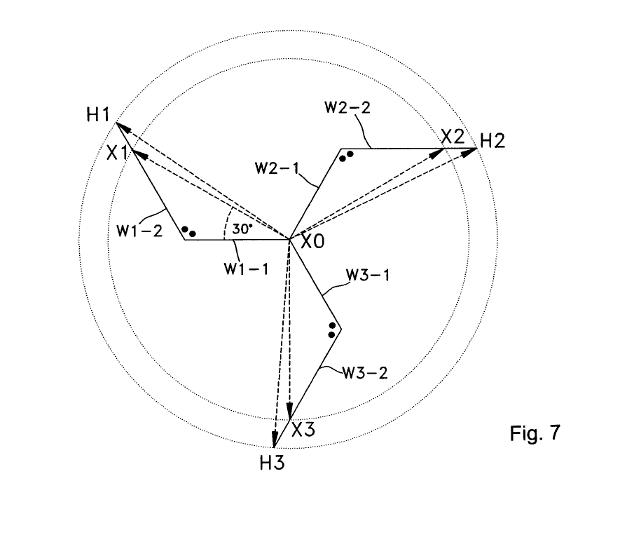

FIG. 7 illustrates a single-output configuration of a step-down autotransformer according to the invention. In this embodiment, the Phase 1 input H1 is connected to a winding W1-2 having a negative orientation on the Phase 1 core leg, which in turn is connected to a winding W1-1 having a positive orientation on the Phase 2 core leg. Similarly, the Phase 2 input H2 is connected to a winding W2-2 having a negative orientation on the Phase 2 core leg; which in turn is connected to a winding W2-1 having a positive orientation on the Phase 3 core leg. The Phase 3 input H3 is connected to a winding W3-2 having a negative orientation on the Phase 3 core leg, which in turn is connected to a winding W3-1 having a positive orientation on the Phase 1 core leg.

For the secondary in the autotransformer of FIG. 7, there is only one output on each phase. The Phase 1 output X1 is tapped from the winding W1-2 to provide the desired output voltage. The Phase 2 output X2 is tapped from the winding W2-2 to provide the desired output voltage. The Phase 3 output X3 is tapped from the winding W3-2 to provide the desired output voltage. In this embodiment, there is no phase shift for cancellation of 5^{th} and 7^{th} harmonic currents. There is however, cancellation or substantial reduction of the third harmonic and other triplen harmonics from the upstream neutral return path because each output is connected to the neutral through windings on different core legs, such that the number of turns of windings between the neutral and each output oriented in a positive direction is substantially equal to the number of turns of windings between the neutral and each output oriented in a negative direction, thereby providing low ZPS impedance. This configuration also provides a neutral return path for 1-phase fault currents.

Those skilled in the art will appreciate that it is not necessary that for each individual output the number of turns of windings between the neutral and the output oriented in a positive direction be exactly equal to the number of turns of windings between the neutral and the output oriented in a negative direction. The low ZPS impedance pathway is formed because the number of turns of windings between the neutral and each output oriented in a positive direction is substantially equal to the number of turns of windings between the neutral and each output oriented in a negative direction.

Various embodiments of the present invention having been thus described in detail by way of example, it will be apparent to those skilled in the art that variations and modifications may be made without departing from the invention. The invention includes all such variations and modifications as fall within the scope of the appended claims.

What is claimed is:

1. A step-down autotransformer for a power distribution system with 1-phase non-linear loads, comprising:
a core having three core legs,
for each phase:
a plurality of windings electrically connected and distributed amongst the core legs,
at least one output for connection to one phase of the power distribution network, the output being connected to a neutral through windings on different core legs, such that the number of turns of windings between the neutral and the output oriented in a positive direction is substantially equal to the number of turns of windings between the neutral and the output oriented in a negative direction, and
an input for connection to one phase of a three phase power supply, disposed at the end of the input winding, the output comprising a tap from the input winding,
whereby for each phase the output has a different voltage than the input and zero phase sequence harmonic currents are substantially reduced or cancelled by the substantially equal number of turns of windings oriented in the positive and negative directions between the output and the neutral.

2. The transformer of claim 1 comprising, for each phase, at least one output pair comprising first and second outputs for connection to one phase of the power distribution network.

3. The transformer of claim 2 wherein the first and second outputs are phase shifted 30 degrees relative to each other.

4. The transformer of claim 2 wherein at least one output in each output pair is connected to the neutral through windings on all three core legs.

5. The transformer of claim 1 wherein the different voltage is a lower voltage.

6. The transformer of claim 5 wherein one output in the output pair is disposed at the end of a winding.

7. A step-down autotransformer for a power distribution system with 1-phase non-linear loads, comprising:
a core having three core legs,
for each phase:
a plurality of windings electrically connected and distributed amongst the core legs,
at least one output pair comprising first and second outputs for connection to one phase of the power distribution network, the first and second outputs being phase shifted relative to each other, each output pair being connected to the neutral through windings on all three core legs, such that the number of turns of windings between the neutral and each output oriented in a positive direction is substantially equal to the number of turns of windings between the neutral and each output oriented in a negative direction,
the first output comprising a tap from an input winding at a position at which a voltage of the first output is substantially equal to a voltage at the second output, and
an input for connection to one phase of a three phase power supply, disposed at the end of the input winding,
whereby for each phase the outputs have a different voltage than the input, 5^{th} and 7^{th} harmonic currents are substantially reduced or cancelled by the phase shift between outputs, and zero phase sequence harmonic currents are substantially reduced or cancelled by the substantially equal number of turns of windings oriented in the positive and negative directions between each output and the neutral.

8. The transformer of claim 7 wherein the first and second outputs are phase shifted 30 degrees relative to each other.

9. The transformer of claim 7 wherein the different voltage is a lower voltage.

10. The transformer of claim 8 wherein one output in the output pair is disposed at the end of a winding.

11. A method of supplying power to a power distribution system with 1-phase non-linear loads via a step-down autotransformer comprising a core having three core legs and, for each phase, a plurality of windings electrically connected and distributed amongst the core legs, at least one output for connection to one phase of the power distribution network, the output being connected to a neutral through windings on different core legs, such that the number of turns of windings between the neutral and the output oriented in a positive direction is substantially equal to the number of turns of windings between the neutral and the output oriented in a negative direction, and an input for connection to one phase of a three phase power supply, disposed at the end of the input winding, the output comprising a tap from the input winding, the method comprising the steps of:
a. supplying an input voltage from an uninterruptible power supply (UPS) to the input of each phase, and
b. supplying a different voltage from at least one output to the power distribution system.
whereby for each phase, zero phase sequence harmonic currents are substantially reduced or cancelled and thereby substantially or completely prevented from entering the power distribution system and a low zero phase sequence return path is provided for 1-phase fault currents.

12. The method of claim 11 wherein the transformer comprises, for each phase, at least one output pair comprising first and second outputs for connection to one phase of the power distribution network.

13. The method of claim 12 wherein the first and second outputs are phase shifted 30 degrees relative to each other.

14. The method of claim 12 wherein at least one output in each output pair is connected to the neutral through windings on all three core legs.

15. The method of claim 14 wherein the different voltage is a lower voltage.

16. The method of claim 15 wherein one output in the output pair is disposed at the end of a winding.
